(19) United States
(12) Patent Application Publication
(10) Pub. No.: US 2015/0171770 A1
(43) Pub. Date: Jun. 18, 2015

(54) DIFFERENTIAL GATE RESISTOR DESIGN FOR SWITCHING MODULES IN POWER CONVERTER

(71) Applicants: Robert Gregory Wagoner, Salem, VA (US); Yong Xu, Shanghai (CN); Li Weng, Shanghai (CN); Hao Yu, Shanghai (CN)

(72) Inventors: Robert Gregory Wagoner, Salem, VA (US); Yong Xu, Shanghai (CN); Li Weng, Shanghai (CN); Hao Yu, Shanghai (CN)

(73) Assignee: General Electric Company, Schenectady, NY (US)

(21) Appl. No.: 14/381,598

(22) PCT Filed: Apr. 24, 2012
(86) PCT No.: PCT/CN2012/074578

§ 371 Date: Aug. 28, 2014

(51) Int. Cl. H02M 7/5387; H02M 1/08

(52) U.S. Cl. CPC H02M 7/5387; H02M 1/08; H02M 2001/0054

(57) ABSTRACT

A power converter and a method for improving the output power of the power converter. The method includes independently selecting different gate resistor characteristics for the upper switching element and the lower switching element in the switching modules of the power converter to improve switching performance of both the upper and the lower switching element across a wide range of operating conditions, such as different voltages, currents, and/or operating temperatures.

### FIELD OF THE INVENTION

The present disclosure relates generally to renewable energy sources, and more particularly to a system and method for improving the total output power capability of power converters used in renewable energy applications.

### BACKGROUND OF THE INVENTION

Power converters are used in renewable energy applications to convert electrical power generated by a renewable energy source into power that is suitable for supply to an AC grid. For example, power converters can be used in wind energy applications to convert the alternating current generated by a wind turbine to a desired output frequency (e.g. 50/60 Hz) and voltage level. Power converters can be used in solar energy applications to convert the DC power generated by one or more photovoltaic arrays into suitable AC power for the AC grid.

Power converters typically use a plurality of switching devices, such as insulated gate bipolar transistors (IGBTs) to convert power supplied from an input power source to a suitable output AC power for the AC grid. For instance, the power converters can include a plurality of switching modules with each switching module including an upper switching element and a lower switching element coupled in series. An output of the switching module can be coupled between the upper switching element and the lower switching element. The switching module can further include a diode coupled in parallel with each of the upper switching element and the lower switching element.

The switching performance of the switching elements used in the power converter can have a significant impact on the output of the power converter. This is particularly true in high power converter applications where multiple switching modules are operated in parallel. In these applications, it can be important to balance the current sharing among the parallel switching modules while also controlling the peak voltage on the parallel switching modules. In particular, any imbalance in the current sharing between parallel switching modules can limit the total output current by the highest stressed switching module, with the lower stressed switching modules not achieving their full capability. As a result, current imbalance among the parallel modules can lead to reduced output capability for the power converter.

Balanced current sharing among the parallel switching modules promotes increased reliability. Achieving balanced current sharing among the parallel modules can be difficult, however, as a result of the differing physical current paths for the switching modules due to, for instance, the internal layout of switching modules and bus bars in the power converter. In addition, the switching performance of the upper and lower switching elements in the switching modules can have an impact on current sharing among parallel switching modules.

The switching performance of the switching elements in the switching modules can depend a lot on the gate resistors used in association with gate driver circuits used to drive the switching elements in the switching modules. In typical applications, gate circuits associated with a switching module include the same type of gate resistor network for both the upper and lower switching elements in the switching module. It has been discovered, however, that it can be difficult to select a single type of gate resistor network for both the upper and lower switching elements that provides good switching performance for both the upper and lower switching elements across a wide range of operating conditions, such as different voltages, currents, and or operating temperatures.

Thus, a need exists for a gate circuit design that improves the switching performance of both the upper switching elements and the lower switching elements used in a power converter across a wide range of operating conditions. A gate circuit design that improves current balancing among parallel switching modules in a high power converter would be particularly useful.

### BRIEF DESCRIPTION OF THE INVENTION

Aspects and advantages of the invention will be set forth in part in the following description, or may be obvious from the description, or may be learned through practice of the invention.

One exemplary aspect of the present disclosure is directed to a power converter for converting an input power to an output AC power at a grid frequency. The power converter includes a switching module having a first switching element and a second switching element coupled in series and an output coupled between the first switching element and the second switching element. The power converter includes a driver circuit coupled to the at least one switching module. The driver circuit is configured to provide one or more signals to control switching of the first switching element and the second switching element. The power converter further includes a first gate resistor network coupled between the driver circuit and the first switching element and a second gate resistor network coupled between the driver circuit and the second switching element. Characteristics of the first gate resistor network are different from characteristics of the second gate resistor network.

For instance, characteristics of the first gate resistor network can be selected to improve switching performance of the first switching element by reducing a switching performance parameter (e.g. a voltage oscillation magnitude) for the first switching element. Characteristics of the second gate resistor network can be selected independently of the characteristics of the first gate resistor network to improve switching performance by reducing a switching performance parameter (e.g. a voltage oscillation magnitude) of the second switching element.

Another exemplary aspect of the present disclosure is directed to a method for increasing the output power of a power converter. The power converter includes at least one switching module. The switching module includes a first switching element and a second switching element coupled in series. The power converter further includes a driver circuit configured to provide one or more signals to control switching of the first switching element and the second switching element. The power converter further includes a first resistor network coupled between the driver circuit and the first switching element and a second resistor network coupled between the driver circuit and the second switching element. The method includes selecting characteristics of the first resistor network to improve switching performance of the first switching element; and selecting characteristics of the second resistor network independently of the first resistor network to improve switching performance of the second switching element.

Yet a further exemplary aspect of the present disclosure is directed to a power converter for use in a renewable energy application. The power converter includes a converter configured to convert an input power received from an input power source to DC power and to provide the DC power to a DC link. The power converter further includes an inverter configured to convert the DC power on the DC link to AC power at an AC grid frequency. One or more of the converter or the inverter includes at least one switching module. The switching module includes a first switching element and a second switching element coupled in series. The power converter further includes a gate circuit associated with the switching module. The gate circuit includes a driver circuit configured to provide one or more signals to control switching of the first switching element and the second switching element. The gate circuit further includes a first gate resistor network coupled between the driver circuit and the first switching element and a second gate resistor network coupled between the driver circuit and the second switching element. Characteristics of the first gate resistor network are different from characteristics of the second gate resistor network.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 depicts an exemplary power converter system according to an exemplary embodiment of the present disclosure;

FIG. 2 depicts an exemplary bridge circuit according to an exemplary embodiment of the present disclosure;

FIG. 3 depicts an exemplary gate circuit according to an exemplary embodiment of the present disclosure;

FIG. 4 depicts aspects of an exemplary pulse test for an upper switching element of a switching element;

FIG. 5 depicts aspects of an exemplary pulse test for a lower switching element of a switching element;

FIG. 6 depicts switching performance characteristics for an exemplary upper switching element for a first gate resistor network design;

FIG. 7 depicts switching performance characteristics for an exemplary lower switching element for the first gate resistor network design;

FIG. 8 depicts switching performance characteristics for an exemplary upper switching element for a second gate resistor network design;

FIG. 9 depicts switching performance characteristics for an exemplary lower switching element for the second gate resistor network design;

FIG. 10 depicts switching performance characteristics for an exemplary lower switching element for the second gate resistor network design at an increased operating temperature;

FIG. 11 depicts switching performance characteristics for an exemplary lower switching element for the first gate resistor network design at an increased operating temperature;

FIG. 12 depicts an exemplary gate circuit according to an exemplary embodiment of the present disclosure; and

FIG. 13 depicts switching performance characteristics for an exemplary upper switching element associated with a different manufacturer than the upper switching element of FIG. 6 for the first gate resistor network design.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present disclosure is directed to a system and method for improving the output power capability of a power converter used to convert input power from an input power source, such as a photovoltaic array, a fuel cell, or a wind turbine, to an output AC power at a grid frequency (e.g. 50/60 Hz) suitable for application to an AC grid. The power converter can include a plurality of switching modules coupled in parallel to provide increased output power capability of the power converter. Each of the switching modules includes an upper switching element (such as an insulated gate bipolar transistor (IGBT)) coupled in series with a lower switching element. The upper switching element can be coupled in parallel with a first diode and the lower switching element can be coupled in parallel with a second diode. An output of the switching module can be coupled between the upper switching element and the lower switching element.

A driver circuit can be configured to provide one or more signals to control switching of the upper switching element and the lower switching element to provide a desired output. The driver circuit can provide signals to the upper switching element through a first gate resistor network and can provide signals to the lower switching element through a second gate resistor network. The switching performance of the upper switching element and the lower switching element can depend significantly on characteristics of their associated gate resistor networks.

It has been discovered that the commutating inductances of the upper switching element and the lower switching element in power converters can be different. Without being bound to any particular theory of operation, the commutating inductances of the upper and the lower switching element can be different as a result of reverse recovery characteristics of diodes used in association with the switching modules coupled with stray inductances in the power converter. The differing commutating inductances of the upper switching element and the lower switching element can make it difficult to identify a single gate resistor characteristic which can provide ideal switching performance for both the upper and lower switching element across a wide range of operating conditions, such as across different voltages and currents and different operating temperatures.

To enhance the switching performance of both the upper and the lower switching elements in the switching module, aspects of the present disclosure are directed to independently selecting different gate resistor characteristics for the upper switching element and the lower switching element to improve switching performance, for instance by reducing voltage oscillations during switching, of both the upper and the lower switching element.

According to particular aspects of the present disclosure, the independently selected gate resistor designs for the upper and lower switching element can be provided on the same gate circuit board. As a result, both the upper and the lower switching elements can obtain improved switching performance, including reduced switching losses and reduced peak voltage, with a single gate circuit board. The single gate circuit board can provide improved switching performance across a wide variety of operating conditions. The improved switching performance can increase current balance among parallel switching modules, leading to increased output power of the power converter.

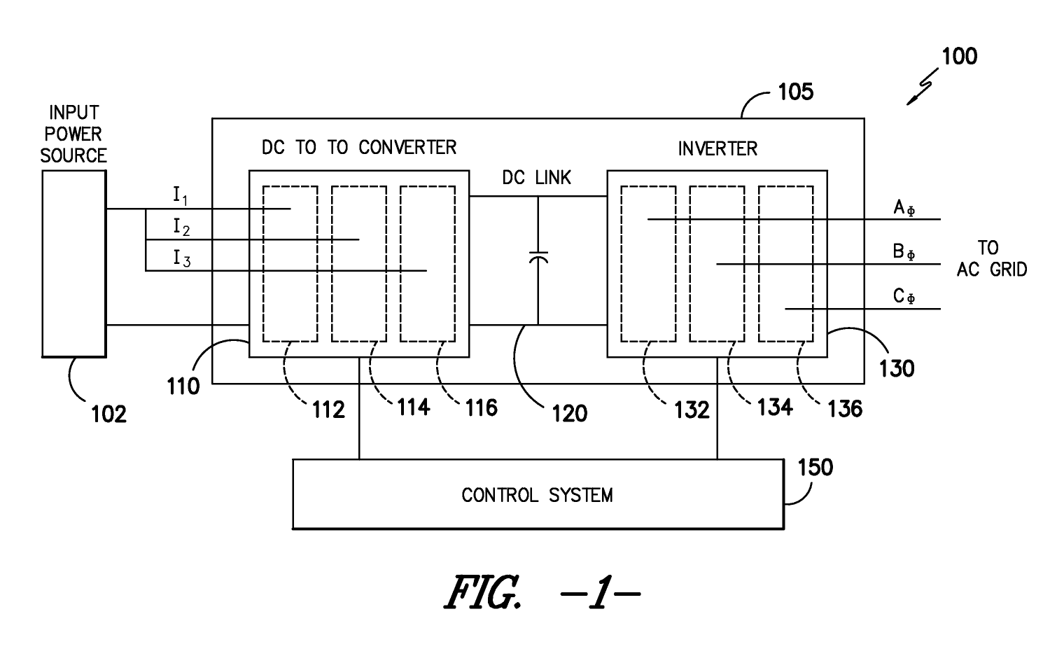

FIG. 1 depicts an exemplary power converter system 100 according to an exemplary aspect of the present disclosure. The power converter system 100 can be used to convert power generated by an input power source 102, such as a photovoltaic array, into AC power at a grid frequency (e.g. 50/60 Hz) suitable for supply to an AC grid. While the present disclosure will be discussed with reference to a power converter system used to convert energy generated by a photovoltaic array, those of ordinary skill in the art, using the disclosures provided herein, should understand that the power converter can similarly be used to convert power supplied from other energy sources, such as a fuel cell or a wind turbine.

The power converter system 100 includes a power converter 105 and a control system 150 configured to control operation of the power converter 105. The power converter 105 is used to convert DC power generated by one or more photovoltaic array(s) 102 into AC power suitable for feeding to the AC grid. The power converter 105 depicted in FIG. 1 is a two-stage power converter that includes a DC to DC converter 110 and an inverter 130.

The DC to DC converter 110 can be a boost converter configured to boost the DC voltage supplied by the PV array(s) and to provide the DC voltage to a DC link 120. The DC link 120 couples the DC to DC converter 110 to the inverter 130. As illustrated, the DC to DC converter 110 can include one or more bridge circuits 112, 114, and 116. Each of the bridge circuits 112, 114, and 116 can include a plurality of switching modules used to generate the DC power provided to the DC link 120. Each of the plurality of input bridge circuits 112, 114, and 116 can be associated with an input feed line to the DC to DC converter 110. DC to DC converter 110 can be a part of or integral with inverter 130 or can be a separate stand alone structure. In addition, more than one DC to DC converter 110 can be coupled to the same inverter 130 through one or more DC links. While a boost converter is depicted in FIG. 1, those of ordinary skill in the art, using the disclosures provided herein, should understand that any DC to DC converter can be used as the first stage of power converter 105, such as a boost converter, buck converter, or buck/boost converter.

The inverter 130 converts the DC power provided to the DC link 120 into AC power at a grid frequency suitable for feeding to the AC grid. The inverter 130 can be configured to provide a multiphase output, such as a three-phase output to the AC grid. The inverter 130 can include a plurality of inverter bridge circuits 132, 134, and 136. Each of the plurality of inverter bridge circuits 132, 134, and 136 can be associated with an output phase of the power converter 105. Similar to the input bridge circuits, each of the plurality of inverter bridge circuits can include a plurality of switching modules, such as IGBT modules, coupled in parallel to provide increased power output capability of the power converter systems.

Control system 150 can include one or more controllers or other control devices configured to control various components of the power converter system 100, including both the DC to DC converter 110 and the inverter 130. For instance, the control system 150 can send gate timing commands to the DC to DC converter 110 to regulate the output of the DC to DC converter 110 pursuant to a control method that regulates the duty cycles of the switching elements (e.g. IGBTs, metal oxide semiconductor field effect transistors (MOSFETs), or other power electronic devices) used in the DC to DC converter 110. Control system 150 can also regulate the output of inverter 130 by providing gate timing commands to switching elements (e.g. IGBTs, MOSFETs or other power electronic devices) in the inverter 130. The gate timing commands control the pulse width modulation provided by switching devices to provide a desired real and/or reactive output by the inverter 130.

Control system 150 can also be used to control various other components of the power converter system 100, such as circuit breakers, disconnect switches, and other devices to control operation of the power converter system 100. The control system 150 can include any number of control device(s) such as processor(s), microcontroller(s), microcomputer(s), programmable logic controller(s), application specific integrated circuit(s) or other suitable control device(s).

In one aspect, the control system 150 can include one or more memory element(s) including, but not limited to, RAM, ROM, hard drives, flash drives, or other memory devices. Such memory element(s) may generally be configured to store suitable computer-readable instructions that, when implemented by a processor(s), configure the control system 150 to perform various functions including, but not limited to, transmitting suitable control signals to one or more components of the power converter system 100. Additionally, the control system 150 can also include one or more communications interfaces to facilitate communications between the control system and the various components of the power converter system 100.

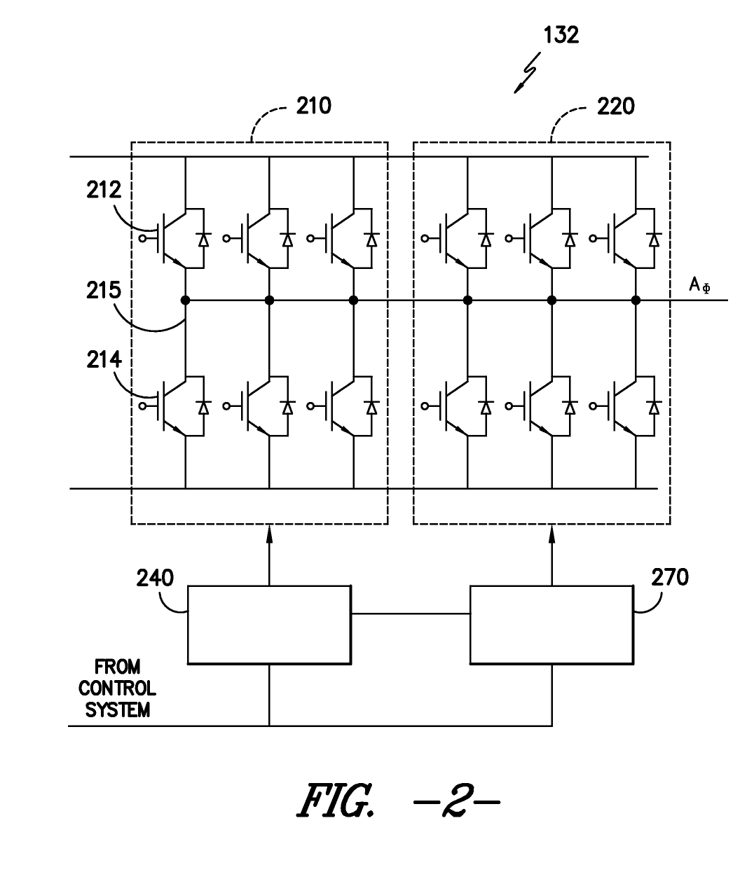

FIG. 2 depicts an exemplary bridge circuit that can be used as part of the power converter 105. FIG. 2 will be discussed with reference to inverter bridge circuit 132 configured to provide an output A of the inverter 130 for exemplary purposes. Those of ordinary skill in the art, using the disclosures provided herein, should understand that the bridge circuit of FIG. 2 could be any bridge circuit in the power converter system, such as any of input bridge circuits 112, 114, or 116 or any of inverter bridge circuits 132, 134, or 136.

As shown, inverter bridge circuit 132 includes a plurality of switching modules 210 and 220 coupled in parallel. The switching modules 210 and 220 provide a common output that serves as the output A of the inverter 130. Although, two switching modules 210 and 220 are illustrated in FIG. 2, more or less switching modules could be used depending on the application of the power converter. As will be discussed below, the switching modules 210 and 220 can be made by different manufacturers.

Each of the switching modules 210 includes at least one switching circuit 215 that includes an upper switching element 212 and a lower switching element 214. In a particular embodiment, the upper switching element 212 and the lower switching element 214 can include insulated gate bipolar transistors (IGBTs). However, other suitable power electronic devices could be used as upper switching element 212 and lower switching element 214. For instance, the switching elements 212 and 214 could be power metal oxide semiconductor field effect transistors (MOSFETs) or other suitable switching devices.

The switching modules 210 and 220 depicted in FIG. 2 each include three switching circuits 215 coupled in parallel. Those of ordinary skill in the art, using the disclosures provided herein, should understand that any number of switching circuits 215 can be provided as part of switching modules 210 and 220 without deviating from the scope of the present disclosure. According to particular aspects of the present disclosure, the three switching circuits 215 for the switching modules 210 and 220 can be implemented on a common circuit board.

An exemplary switching circuit 215 can be arranged as follows. The upper switching element 212 can be a first IGBT that includes a first gate terminal, a first collector terminal, and a first emitter terminal. The lower switching element 214 can be a second IGBT that includes a second gate terminal, a second collector terminal, and a second emitter terminal. The first IGBT and the second IGBT can be arranged such that the first emitter terminal is coupled to the second collector terminal. An output of the switching circuit can be coupled between the first IGBT and the second IGBT where the first emitter terminal is coupled to the second collector terminal. The switching circuit 215 can include a first diode coupled in parallel with the first IGBT and a second diode coupled in parallel with the second IGBT.

As shown in FIG. 2, each switching module 210 and 220 has its own associated gate circuit 240 and 270. The gate circuit 240 includes a driver circuit and resistive networks that provide gate signals to the gate terminals of the upper switching elements 212 and lower switching elements 214 of its associated switching module 210. The gate circuit 270 includes a driver circuit and resistive networks that provide gate signals to the gate terminals of the upper switching elements 212 and lower switching elements 214 of its associated switching module 220. The gate signals can be provided pursuant to control signals from the control system 150 of FIG. 1 to control the switching of the upper switching elements 212 and the lower switching elements 214 in a switching module to provide a desired output for the power converter system 100.

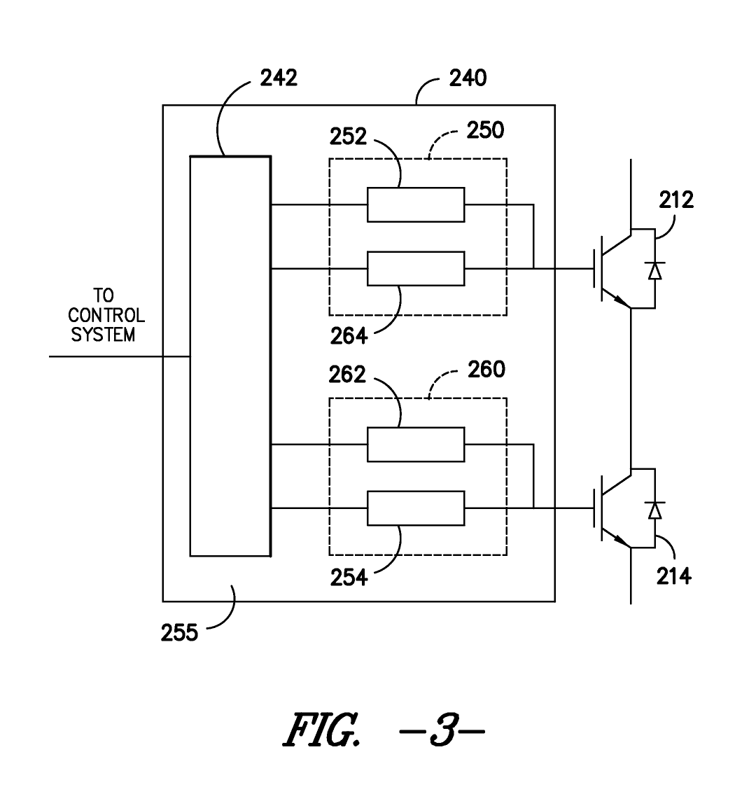

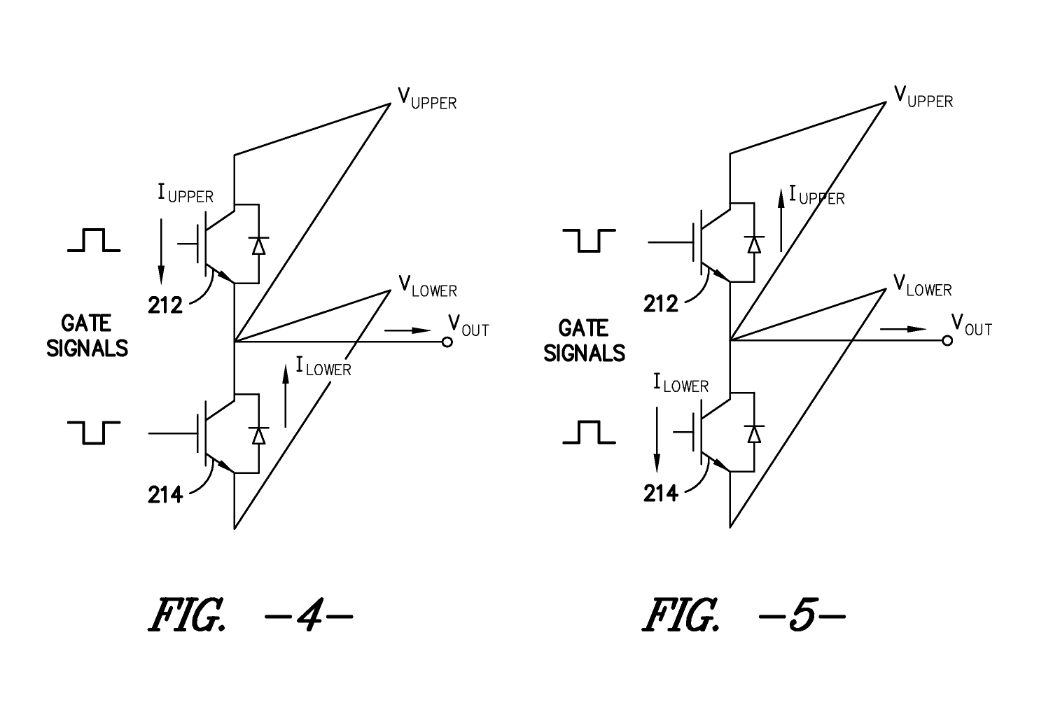

FIG. 3 depicts a block diagram of an exemplary gate circuit 240 used to provide gate signals to upper switching elements 212 and lower switching elements 214 of switching module 210. While gate circuit 240 is described with reference to providing gate signals to a single upper switching element 212 and single lower switching element 214 for sake of clarity and illustration, it should be understood that gate circuit 240 can be configured to provide gate signals to all upper switching elements 212 and lower switching elements 214 in switching module 210.

Gate circuit 240 includes a driver circuit 242 configured to generate a voltage signal to control the switching of upper switching element 212 and lower switching element 214 pursuant to control commands received from the control system 150. The driver circuit 242 can include one or more electronic devices configured to generate a voltage signal suitable to drive the upper switching element 212 and the lower switching element 214. The gate circuit 240 further includes a first gate resistor network 250 coupled between the driver circuit 242 and the upper switching element 212 and a second gate resistor network 260 coupled between the driver circuit 242 and the lower switching element 214. According to particular aspects of the present disclosure, the driver circuit 242, the first gate resistor network 250, and the second gate resistor network 260 can be provided on the same circuit board 255.

The first gate resistor network 250 can include a first turn on resistor 252 and a first turn off resistor 254. The driver circuit 242 can be configured to provide gate signals to the upper switching element 212 through the first turn on resistor 252 when the driver circuit 242 activates or turns on the upper switching element 212. The driver circuit 242 can be configured to provide gate signals to the upper switching element 212 through the first turn off resistor 254 when the upper switching element 212 is not activated or is off.

Similar to the first gate resistor network 250, the second gate resistor network 260 can include a second turn on resistor 262 and a second turn off resistor 264. The driver circuit 242 can be configured to provide gate signals to the upper switching element 212 through the second turn on resistor 262 when the driver circuit 242 activates or turns on the lower switching element 214. The driver circuit 242 can be configured to provide gate signals to the lower switching element 214 through the second turn off resistor 264 when the lower switching element 214 is not activated or is off.

As will be discussed in more detail below, it has been discovered that the upper switching element 212 and the lower switching element 214 can have different commutating inductances during operation due to, for instance, characteristics of the diodes coupled in parallel with the switching elements 212 and 214 as well as the location of the switching elements 212 and 214 within the power converter. As a result, it can be difficult to specify a gate resistor network that can be suitable for both the upper switching element 212 and the lower switching element 214 across a wide range of operating conditions, such as different temperature conditions.

As a result, aspects of the present disclosure are directed to selecting characteristics of the first resistor network 250 to improve switching performance (e.g. by reducing a switching performance parameter such as a voltage oscillation magnitude) of the upper switching element 212 across a wide range of conditions, such as across an operating temperature range from 25° C. to 125° C. Characteristics of the second resistor network 260 are then selected independently of the characteristics of the first resistor network 250 to improve switching performance (e.g. by reducing a switching performance parameter such as a voltage oscillation magnitude) of the lower switching element 214 across a wide range of operating conditions, such as across an operating temperature range from 25° C. to 125° C. The first resistor network 250 and the second resistor network 260 can then be provided on the same gate circuit board to provide an improve gate circuit design for the power converter system 100.

In this manner, characteristics of the first gate resistor network 250 are selected to be different from characteristics of the second gate resistor network 260 to improve the switching performance of both the upper switching element 212 and the lower switching element 214. More particularly, the first turn on resistor 252 of the first gate resistor network 250 can have a resistance that is different from a resistance of the second turn on resistor 262 of the second gate resistor network 260. Alternatively or in addition, the first turn off resistor 254 of the first gate resistor network 250 can have a resistance that is different from a resistance of the second turn off resistor 264 of the second gate resistor network 260.

To illustrate the advantages of selecting characteristics of the first gate resistor network independent of characteristics of the second gate resistor network, an exemplary application of the present disclosure will now be provided. A pulse test was conducted for both an upper switching element 212 and a lower switching element 214 of a Fuji 6MBI450U4-120 switching module with varying gate resistor networks for both the upper switching element 212 and the lower switching element 214 across a variety of operating temperatures.

FIG. 4 illustrates the pulse test for the upper switching element 212. In particular, gate commands are provided to control the upper switching element 212 and the lower switching element 214. In particular, gate commands are provided such that the upper switching element 212 and the lower switching element 214 are switched opposite each other. In other words, while the upper switching element 212 is turned on, the lower switching element is turned off.

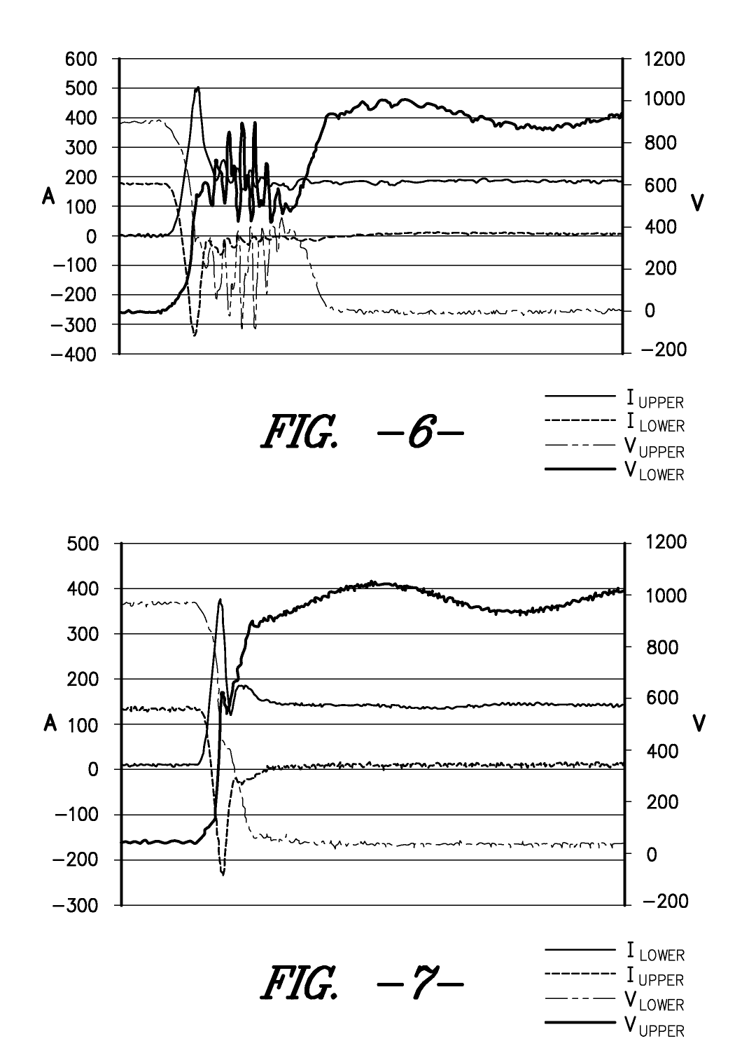

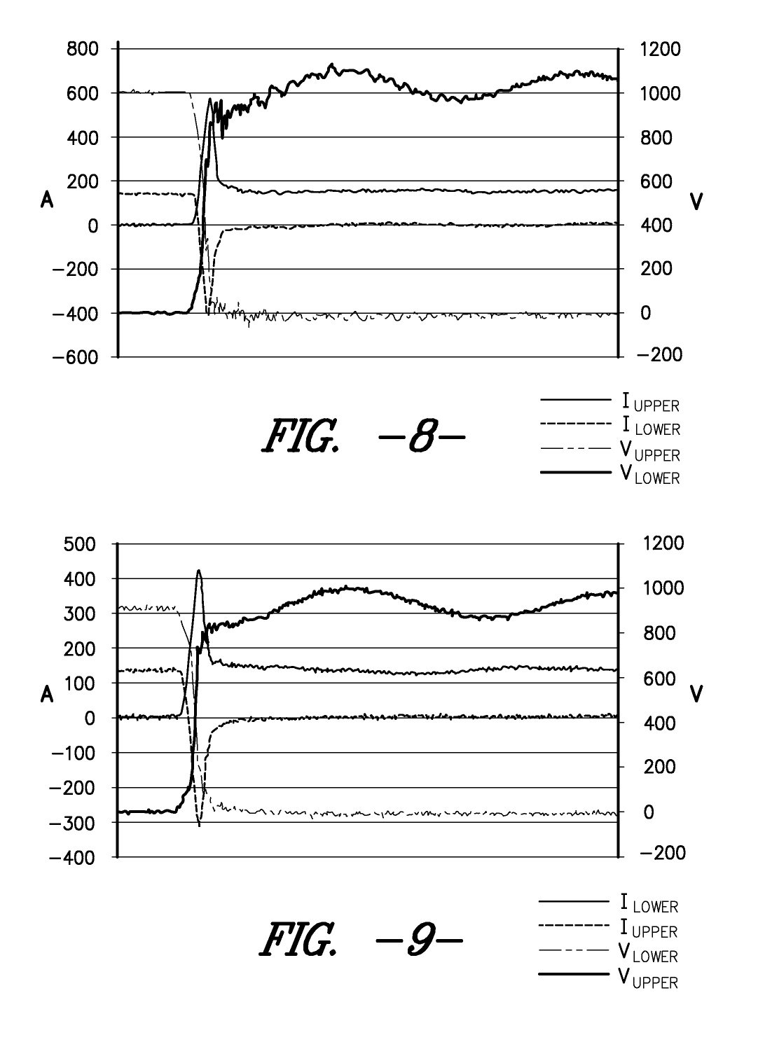

As shown in FIG. 4, switching performance characteristics of the upper switching element 210 can be monitored while the upper switching element is turned on. The voltage Vᵤₚₚₑᵣ is the voltage across the upper switching element 212 while the voltage V_{lower} is the voltage across the lower switching element 214 (e.g. measured across the diode coupled in parallel the lower switching element 214). The current Tᵤₚₚₑᵣ is the current through the upper switching element 212 while the current I_{lower} is the current through the diode coupled in parallel with the lower switching element 214. The switching circuit including upper switching element 212 and lower switching element provide an output voltage Vₒᵤₜ. The results of various pulse tests for varying gate resistor networks for the upper switching element 212 across a variety of operating conditions will be discussed with reference to FIGS. 6 and 8.

As shown in FIG. 4, switching performance characteristics of the upper switching element 210 can be monitored while the upper switching element is turned on. The voltage Vᵤₚₚₑᵣ is the voltage across the upper switching element (e.g. measured across the diode coupled in parallel with the upper switching element 212) while the voltage V_{lower} is the voltage across the lower switching element 214. The current I_{lower} is the current through the lower switching element 214 while the current Iᵤₚₚₑᵣ is the current through the diode coupled in parallel with the upper switching element 212. The results of various pulse tests at varying gate resistor networks for the lower switching element 214 across a variety of operating temperatures will be discussed with reference to FIGS. 7 and 9-11.

FIG. 6 depicts switching performance characteristics of the upper switching element 212 of a Fuji 6MBI450U4-120 switching module for a first gate resistor network design when the turn on resistor is 4.5 ohms and the turn off resistor is 28 ohms. As shown, large voltage oscillations appear in the voltage Vᵤₚₚₑᵣ across the upper switching element 212 and the voltage V_{lower} across the diode coupled in parallel with the lower switching element 214. These voltage oscillations are undesirable, particularly when the output current increases to a certain level. Selecting a gate circuit design where the turn on resistor is 4.5 ohms and the turn off resistor is 28 ohms may not be suitable for achieving desired switching performance of the upper switching element 212. Thus, it can be advantageous to select a gate circuit design to reduce a switching performance parameter, such as a voltage oscillation magnitude, associated with the upper switching element.

FIG. 7 depicts switching performance characteristics of the lower switching element 214 of a Fuji 6MBI450U4-120 switching module for the first gate resistor network design when the turn on resistor is 4.5 ohms and the turn off resistor is 28 ohms. Comparing FIG. 6 and FIG. 7, it can be seen that switching performance is quite different for the upper switching element 212 and the lower switching element 214 at the same gate resistors (turn on resistor is 4.5 ohms and the turn off resistor is 28 ohms). Large voltage oscillations appear in the upper switching element but are not present in the lower switching element. This difference can be caused by different commutating inductances for the upper switching element 212 and the lower switching element 214. As a result, a gate circuit design where the turn on resistor is 4.5 ohms and the turn off resistor is 28 ohms may be suitable for achieving desired switching performance (e.g. reduced voltage oscillations) of the lower switching element 214 but not for the upper switching element 212.

To reduce a switching performance parameter such as voltage oscillation magnitude of the upper switching element 212, the resistance of the turn on resistor can be decreased from 4.5 ohms to a smaller value to get improved switching performance for both the upper switching element 212 and the lower switching element 214. For example, FIG. 8 depicts switching performance characteristics of the upper switching element 212 of a Fuji 6MBI450U4-120 switching module for a second gate resistor network design when the turn on resistor is 1.95 ohms and the turn off resistor is 28 ohms. As shown, the voltage oscillations that were present as a result of the previous gate resistor design have been reduced. Accordingly, a gate resistor design where the turn on resistor is 1.95 ohms and the turn off resistor is 28 ohms can be suitable for the upper switching element 212.

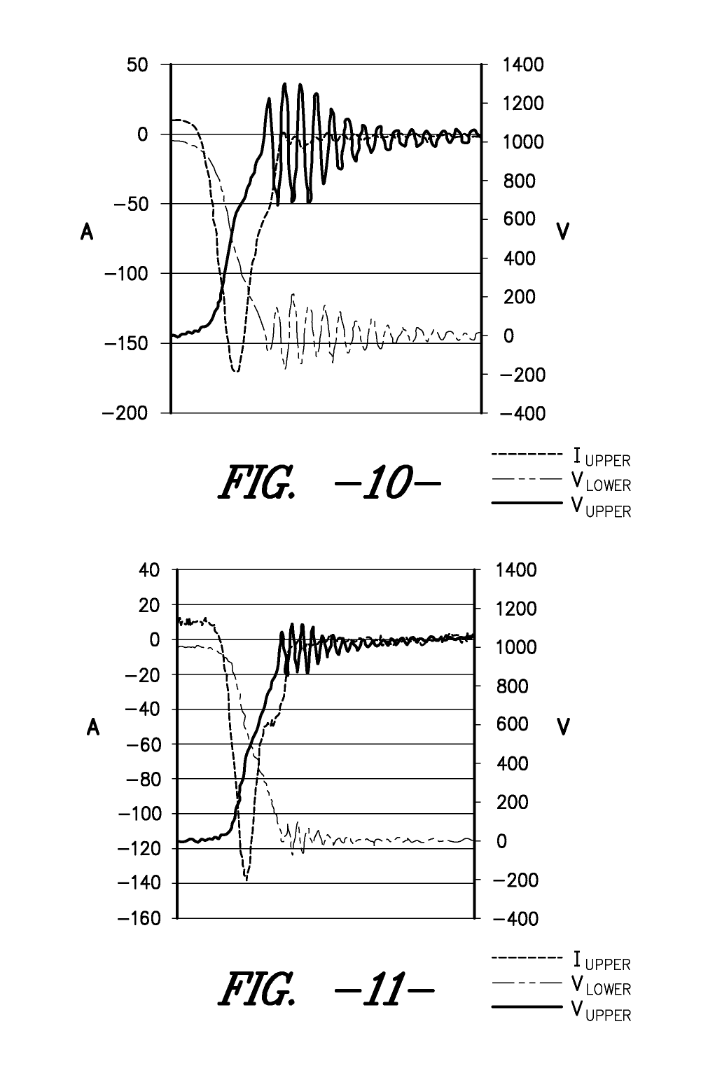

This gate resistor design can also be suitable for the lower switching element 214 in limited operating conditions. For instance, FIG. 9 depicts switching performance characteristics of the lower switching element 214 of a Fuji 6MBI450U4-120 switching module for the second gate resistor network design when the turn on resistor is 1.95 ohms and the turn off resistor is 28 ohms. As shown, there are very little voltage oscillations and an increased current, indicating good switching performance for the lower switching element 214.

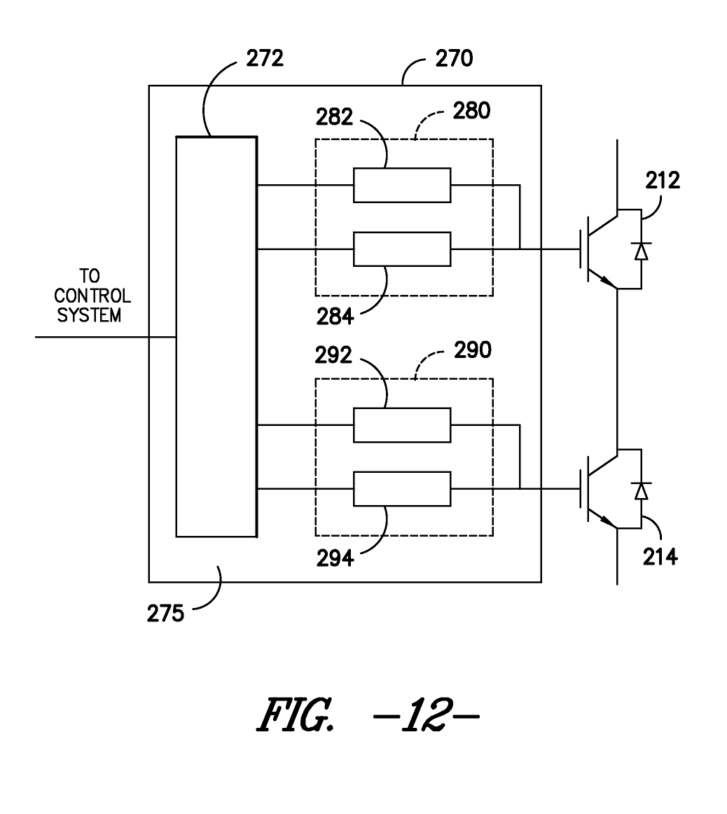

However, when the test temperature is increased from 25° C. to 125° C., the switching performance of the lower switching element 214 with the second gate resistor network design can be diminished. For instance, FIG. 10 depicts switching performance characteristics of the lower switching element 214 of a Fuji 6MBI450U4-120 switching module for the second gate resistor network design when the turn on resistor is 1.95 ohms and the turn off resistor is 28 ohms at an operating temperature of 125° C. As shown, there are voltage oscillations at turn-on when the turn on resistor is at 1.95 ohms. These voltage oscillations are not obvious for the upper switching element 212. As shown in FIG. 11, however, the voltage oscillations for the lower switching element 214 are reduced when the turn on resistor is at 4.5 ohms.

As illustrated by the above example, different gate resistor designs for the upper switching element 212 and the lower switching element 214 lead to improved switching performance (e.g. reduced voltage oscillations) for both the upper switching element 212 and the lower switching element 214 across a wide range of operating conditions, such as across operating temperatures from 25° C. to 125° C. In particular, a gate resistor design that includes a turn on resistor of 1.95 ohms and a turn off resistor of 28 ohms can provide improved switching performance (e.g. reduced voltage oscillations) for an upper switching element 212 of a Fuji 6MBI450U4-120 switching module. A gate resistor design that includes a turn on resistor of 4.5 ohms and a turn off resistor of 28 ohms can provide improved switching performance (e.g. reduced voltage oscillations) for a lower switching element 214 of a Fuji 6MBI450U4-120 switching module. In accordance with aspects of the present disclosure, these different gate resistor networks can be provided on the same gate circuit card to provide improved output power capability of a power converter.

Different gate resistor networks can also be suitable for switching modules made by different manufacturers. For instance, as shown in FIG. 2, a bridge circuit of a power converter can include a plurality of switching modules 210 and 220 coupled in parallel. Switching module 210 can be made by a first manufacturer and switching module 220 can be made by a second manufacturer. Each switching module 210 and 220 has its own respective gate circuit 240 and 270. The switching elements of the switching modules 210 and 220 can have different switching performance characteristics for the same gate resistor network designs.

For instance, FIG. 13 depicts switching performance characteristics of an upper switching module 212 of an Infineon FS450R12KE3 switching module for the first gate resistor network design where the turn on resistor has a turn on resistance of 4.5 ohms and a turn off resistance of 28 ohms. Comparing FIG. 13 to FIG. 6, the switching performance of the Infineon upper switching element is quite different from the Fuji upper switching element. As a result, characteristics of gate resistor networks associated with the switching module 220 can be selected to be different from those of gate resistor networks associated with switching module 210 to provide improved performance of the power converter.

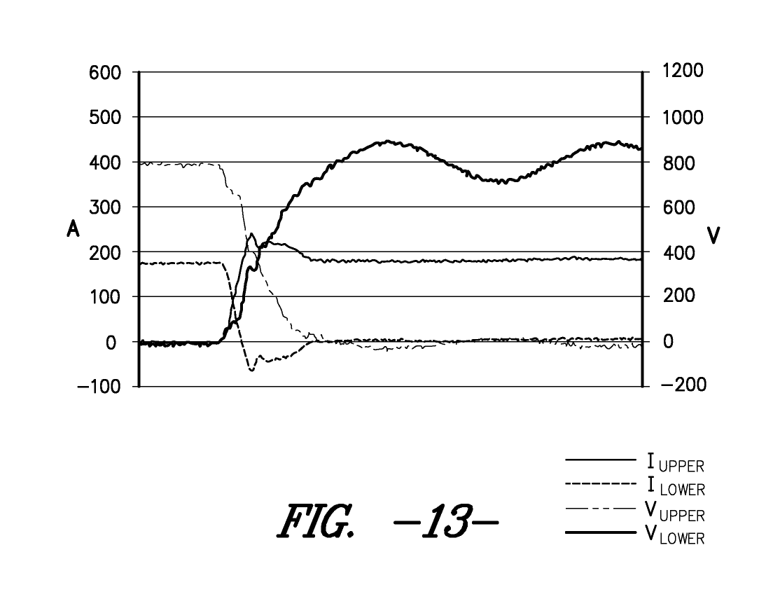

FIG. 12 depicts an exemplary gate circuit 270 associated with the switching module 220. Similar to gate circuit 240 of FIG. 3, gate circuit 270 includes a driver circuit 272 configured to generate a voltage signal to control the switching of upper switching element 212 and lower switching element 214 pursuant to control commands received from the control system 150 (shown in FIG. 1). The driver circuit 272 can include one or more electronic devices configured to generate a voltage signal suitable to drive the upper switching element 212 and the lower switching element 214. The gate circuit 270 further includes a third gate resistor network 280 coupled between the driver circuit 272 and the upper switching element 212 and a fourth gate resistor network 290 coupled between the driver circuit 272 and the lower switching element 214. According to particular aspects of the present disclosure, the driver circuit 272, the third gate resistor network 280, and the fourth gate resistor network 290 can be provided on the same circuit board 275.

The third gate resistor network 280 can include a third turn on resistor 282 and a third turn off resistor 284. The fourth gate resistor network 290 can include a fourth turn on resistor 292 and a fourth turn off resistor 294. Characteristics of the third gate resistor network 280 and the fourth gate resistor network 290 can be different from characteristics of the first gate resistor network 250 and the second gate resistor network 260 of the gate circuit 240 associated with switching module 210. For instance, the third turn on resistor 282 can have a resistance that is different from the resistance of the first turn on resistor 252. Alternatively or in addition, the fourth turn on resistor 292 can have a resistance that is different from the resistance of the second turn on resistor 262.

Similar to the gate circuit 240, characteristics of the third gate resistor network 280 can be selected to be different from characteristics of the fourth gate resistor network 290 to improve the switching performance of both the upper switching element 212 and the lower switching element 214. More particularly, the third turn on resistor 282 of the third gate resistor network 280 can have a resistance that is different from a resistance of the fourth turn on resistor 292 of the fourth gate resistor network 290. Alternatively or in addition, the third turn off resistor 284 of the third gate resistor network 280 can have a resistance that is different from a resistance of the fourth turn off resistor 294 of the fourth gate resistor network 290.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A power converter for converting an input power to an output AC power at a grid frequency, comprising:
a bridge circuit having at least one switching module, the switching module comprising a first switching element and a second switching element coupled in series and an output coupled between the first switching element and the second switching element;
a driver circuit coupled to the at least one switching module, the driver circuit configured to provide one or more signals to control switching of the first switching element and the second switching element;
a first gate resistor network coupled between the driver circuit and the first switching element; and
a second gate resistor network coupled between the driver circuit and the second switching element, wherein characteristics of the first gate resistor network are different from characteristics of the second gate resistor network.

2. The power converter of claim 1, wherein characteristics of the first gate resistor network are selected to reduce a switching performance parameter of the first switching element and characteristics of the second gate resistor network are selected independently of the characteristics of the first gate resistor network to reduce a switching performance parameter of the second switching element.

3. The power converter of claim 2, wherein the switching performance parameter comprises a voltage oscillation magnitude.

4. The power converter of claim 1, wherein the first switching element and the second switching element comprise insulated gate bipolar transistors

5. The power converter of claim 1, wherein the first switching element and the second switching element comprise metal oxide semiconductor field effect transistors.

6. The power converter of claim 1, wherein the first resistor network comprises a first turn on resistor and a first turn off resistor and the second resistor network comprises a second turn on resistor and a second turn off resistor.

7. The power converter of claim 6, wherein the first turn off resistor has a resistance that is different from a resistance of the second turn off resistor.

8. The power converter of claim 6, wherein the first turn on resistor has a resistance that is different from a resistance of the second turn on resistor.

9. The power converter of claim 1, wherein the driver circuit, the first resistor network, and the second resistor network are disposed on a single gate circuit board associated with the switching module.

10. The power converter of claim 1, wherein the power converter comprises a second switching module coupled in parallel with the switching module, the second switching module comprising a third switching element and a fourth switching element coupled in series, the output of the second switching module coupled between the third switching element and the fourth switching element.

11. The power converter of claim 10, wherein the power converter comprises a second gate circuit board associated with the second switching module, the second gate circuit board comprising a second driver circuit, a third resistor network coupled between the second driver circuit and the third switching element and a fourth resistor network coupled between the second driver circuit and the fourth switching element, wherein characteristics of the third resistor network are different from characteristics of the fourth resistor network.

12. A method for improving the output power of a power converter, the power converter comprising at least one switching module, the switching module comprising a first switching element and a second switching element coupled in series, the power converter further comprising a driver circuit configured to provide one or more signals to control switching of the first switching element and the second switching element, the power converter further comprising a first resistor network coupled between the driver circuit and first switching element, and a second resistor network coupled between the driver circuit and the second switching element, the method comprising:
selecting characteristics of the first resistor network to reduce a switching performance parameter of the first switching element; and
selecting characteristics of the second resistor network independently of the first resistor network to reduce a switching performance parameter of the second switching element.

13. The method of claim 12, wherein the switching performance parameter comprises a voltage oscillation magnitude.

14. The method of claim 12, wherein the characteristics of the first resistor network are selected to reduce the switching performance parameter of the first switching element based across an operating temperature range of about 25° C. to about 125° C.

15. The method of claim 12, wherein characteristics of the second resistor network are selected to reduce the switching performance parameter of the second switching element across an operating temperature range of about 25° C. to about 125° C.

16. The method of claim 23, wherein the method comprises providing the driver circuit, the first resistor network, and the second resistor network on the same gate circuit board.

17. A power converter for use in renewable energy application, the power converter comprising:
a converter configured to convert an input power received from an input power source to DC power and to provide the DC power to a DC link;
an inverter configured to convert the DC power on the DC link to AC power at an AC grid frequency;
one or more of the converter or the inverter comprising at least one switching module, the switching module comprising a first switching element and a second switching element coupled in series; and
a gate circuit associated with the switching module, the gate circuit comprising a driver circuit configured to provide one or more signals to control switching of the first switching element and the second switching element, the gate circuit further comprising a first gate resistor network coupled between the driver circuit and the first switching element, and a second gate resistor network coupled between the driver circuit and the second switching element, wherein characteristics of the first gate resistor network are different from characteristics of the second gate resistor network.

18. The power converter of claim 17, wherein the first resistor network comprises a first turn on resistor and a first turn off resistor and the second resistor network comprises a second turn on resistor and a second turn off resistor.

19. The power converter of claim 18, wherein the first turn off resistor has a resistance that is different from a resistance of the second turn off resistor.

20. The power converter of claim 18, wherein the first turn on resistor has a resistance that is different from a resistance of the second turn on resistor.
